(19) United States
(12) Patent Application Publication
(10) Pub. No.: US 2017/0254127 A1
(43) Pub. Date: Sep. 7, 2017

(54) HINGE MECHANISM FOR AN ELECTRONIC DEVICE

(71) Applicant: LENOVO (SINGAPORE) PTE. LTD., SINGAPORE (SG)

(72) Inventors: Yoshiharu Uchiyama, Kanagawa-ken (JP); Yasushi Honda, Kanagawa-ken (JP); Seita Horikoshi, Kanagawa-ken (JP); Takehito Yamauchi, Kanagawa-ken (JP)

(21) Appl. No.: 15/448,227

(22) Filed: Mar. 2, 2017

(30) Foreign Application Priority Data
Mar. 2, 2016 (JP) 2016-40042

(51) Int. Cl. E05D 3/14; G06F 1/16; F16C 11/04

(52) U.S. Cl. CPC E05D 3/14; F16C 11/04; G06F 1/1601; E05Y 2900/606

(57) ABSTRACT

A hinge mechanism adapted to openably and closably connect two chassis is disclosed. The hinge mechanism includes a first link member and a second link member, which are provided between a first chassis and a second chassis; a first shaft that pivotably connects the first link member to the first chassis; a second shaft that pivotably connects the first link member to the second chassis; a third shaft that pivotably connects the second link member to the first chassis; and a fourth shaft that pivotably connects the second link member to the second chassis. The first shaft, the second shaft, the third shaft and the fourth shaft are not coaxial.

### PRIORITY CLAIM

The present application claims benefit of priority under 35 U.S.C. §§120, 365 to the previously filed Japanese Patent Application No. JP2016-40042 with a priority date of Mar. 2, 2016, which is incorporated by reference herein.

### TECHNICAL FIELD

The present invention relates to electronic devices in general, and in particular to a hinge mechanism that openably and closably connects two chassis of an electronic device.

### BACKGROUND

An electronic device, such as a cellular phone or a laptop type personal computer (laptop PC), adopts a configuration in which a display chassis is openably and closably connected to a main body chassis by a hinge mechanism.

For example, a convertible PC may include a two-shaft hinge mechanism, which rotatably supports a shaft fixed to the rear edge of a display chassis at the upper end of a hinge block and rotatably supports a shaft fixed to the rear edge of a main body chassis at the lower end of the hinge block, thus enabling the display chassis to be flipped to a 360-degree position.

The present disclosure provides a hinge mechanism that openably and closably connects two chassis of an electronic device.

### SUMMARY

In accordance with an embodiment of the present disclosure, a hinge mechanism includes a first link member and a second link member, which are provided between a first chassis and a second chassis. The hinge mechanism also includes a first shaft that pivotably connects the first link member to the first chassis, a second shaft that pivotably connects the first link member to the second chassis, a third shaft that pivotably connects the second link member to the first chassis, and a fourth shaft that pivotably connects the second link member to the second chassis. The first shaft, the second shaft, the third shaft and the fourth shaft are not coaxial.

All features and advantages of the present disclosure will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a perspective view of an electronic apparatus provided with a hinge mechanism, according to one embodiment;

FIG. 2 is a perspective view of a hinge mechanism according to one embodiment;

FIG. 3 is a plan view of the hinge mechanism from FIG. 2;

FIG. 4 is a plan view of a hinge mechanism according to an alternative embodiment;

FIG. 5 is a side view of the hinge mechanism when the opening angle of a display chassis with respect to a body chassis is zero degree;

FIG. 6 is a side view of the hinge mechanism when the opening angle of the display chassis with respect to the body chassis is 45 degrees;

FIG. 7 is a side view of the hinge mechanism when the opening angle of the display chassis with respect to the body chassis is 90 degrees;

FIG. 8 is a side view of the hinge mechanism when the opening angle of the display chassis with respect to the main body chassis is 135 degrees;

FIG. 9 is a side view of the hinge mechanism when the opening angle of the display chassis with respect to the main body chassis is 180 degrees;

FIG. 10 is a side view of the hinge mechanism when the opening angle of the display chassis with respect to the main body chassis is 225 degrees;

FIG. 11 is a side view of the hinge mechanism when the opening angle of the display chassis with respect to the main body chassis is 270 degrees;

FIG. 12 is a side view of the hinge mechanism when the opening angle of the display chassis with respect to the main body chassis is 315 degrees; and

FIG. 13 is a side view of the hinge mechanism when the opening angle of the display chassis with respect to the main body chassis is 360 degrees.

### DETAILED DESCRIPTION

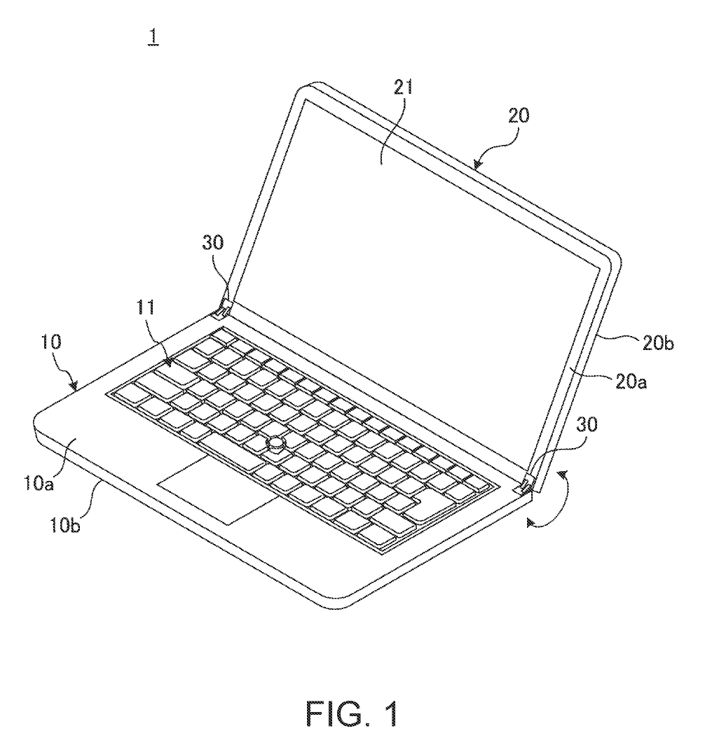

FIG. 1 is a perspective view of an electronic apparatus provided with a hinge mechanism, according to one embodiment. As shown, an electronic apparatus 1 has a main body chassis 10, a display chassis 20, and left and right hinge mechanisms 30. In the following description, the state in which the display chassis 20 is closed (zero-degree position) with respect to the main body chassis 10 from the state illustrated in FIG. 1 is defined as the reference state. In addition, the edges of the display chassis 20 and the main body chassis 10 which are adjacent to the hinge mechanisms 30 will be referred to as the rear edges (rear), the edges thereof on the opposite side will be referred to as the front edges (front), the direction of thickness will be referred to as the vertical direction, and the direction of width will be referred to as the lateral direction.

The electronic apparatus 1 is a so-called convertible PC, in which the hinge mechanisms 30 provided therein enable the electronic apparatus 1 to be ideally used as a laptop PC in the state wherein the display chassis 20 is pivoted to an angle position of approximately 90 degrees with respect to the main body chassis 10 (see FIG. 1), and also ideally used as a tablet PC in the state wherein the display chassis 20 is pivoted to be flipped to a 360-degree position with respect to the main body chassis 10. However, the present invention can be ideally applied to other types of electronic apparatuses, such as a typical laptop PC having, for example, the display chassis 20 pivotable only to an approximately 180-degree position, a cellular phone, a smartphone or an electronic organizer, in addition to the convertible PC described above, insofar as the electronic apparatus has its two chassis openably and closably connected by hinge mechanisms.

The main body chassis 10 is formed in a flat box shape, as illustrated in FIG. 1. The main body chassis 10 is connected to the display chassis 20 by the hinge mechanisms 30 provided at the rear edges thereof. Further, input units, including a keyboard assembly 11, are provided on an upper surface 10a of the main body chassis 10, and various types of electronic components, such as boards, arithmetic units and memories (not illustrated) are provided inside the main body chassis 10. The keyboard assembly 11 may be constituted of, for example, a touch-screen display type (not illustrated) provided on the upper surface 10a of the main body chassis 10.

As illustrated in FIG. 1, the display chassis 20 is formed to have a flat-plate shape that is thinner than the main body chassis 10. The display chassis 20 is connected to the main body chassis 10 by the hinge mechanisms 30 provided at its rear edge. Further, a display, such as a display device 21, is provided on a lower surface 20a of the display chassis 20. The display device 21 is constituted of, for example, a touch-screen liquid crystal display.

The hinge mechanisms 30 are adapted to openably and closably connect two chassis, namely, the main body chassis 10 and the display chassis 20. The hinge mechanisms 30 in the present embodiment are composed of the pair of left and right hinge mechanisms, as illustrated in FIG. 1, and are disposed on the outer side of the display device 21. The hinge mechanisms 30 are pivotally moved the display chassis 20 from the zero-degree position to the 360-degree position with respect to the main body chassis 10 by a link mechanism.

### I. Configuration of a Hinge Mechanism

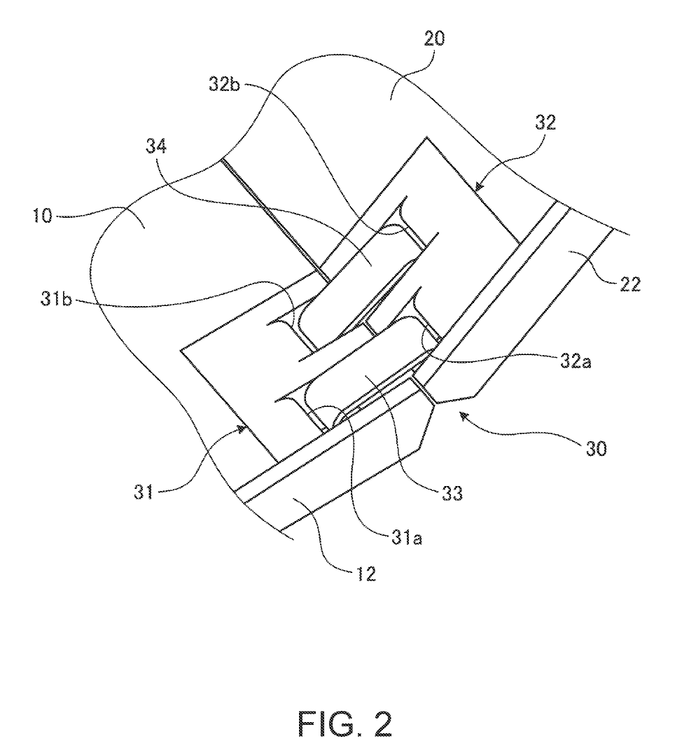

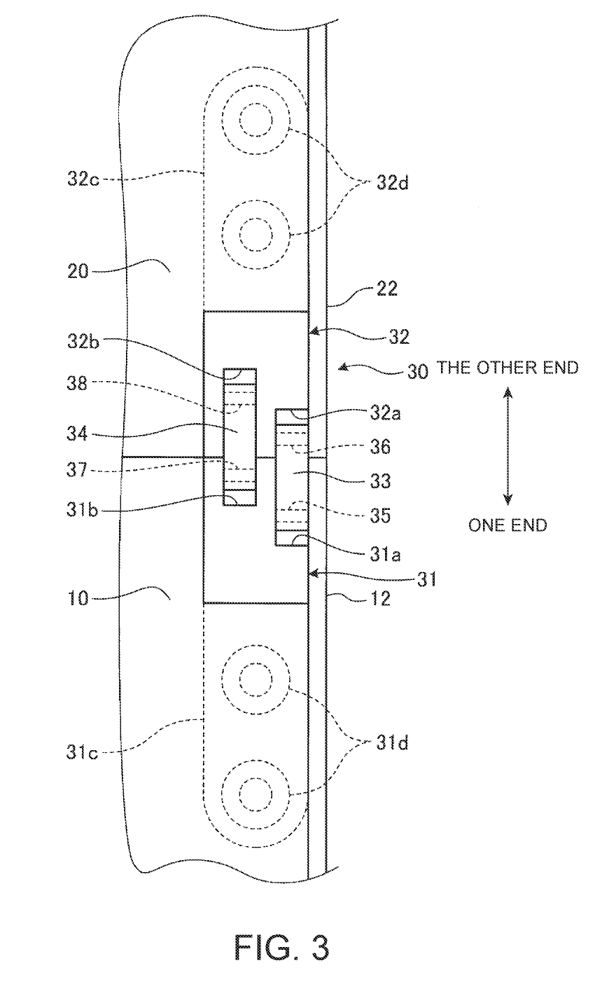

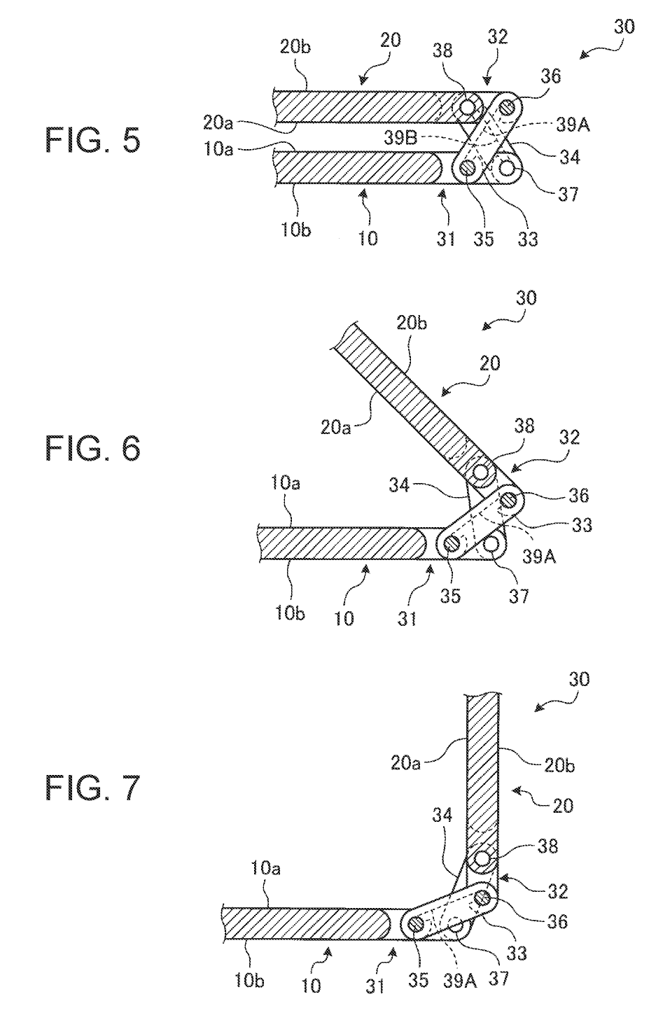

FIG. 2 is an enlarged perspective view of the hinge mechanism 30 on the right side in FIG. 1. FIG. 3 is the plan view illustrating the hinge mechanism 30 in the case where the opening angle of the display chassis 20 with respect to the main body chassis 10 is 180 degrees (see FIG. 9). FIG. 5 is the side view illustrating the hinge mechanism 30 in the case where the opening angle of the display chassis 20 with respect to the main body chassis 10 is zero degree. In this drawing, for the convenience of explanation, frame members 12 and 22 are not illustrated.

As illustrated in FIG. 2, FIG. 3 and FIG. 5, the hinge mechanism 30 includes a first fixed member 31, a second fixed member 32, a first link member 33, a second link member 34, a first shaft 35, a second shaft 36, a third shaft 37, a fourth shaft 38, and torque generating mechanisms 39A, 39B.

The first fixed member 31 is formed in a plate-like shape and disposed adjacently to a frame member 12 of the main body chassis 10, as illustrated in FIG. 2 and FIG. 3. In other words, the first fixed member 31 is disposed at a side edge of the main body chassis 10 that is connected to the display chassis 20 and is disposed at a position adjacent to the frame member 12, which forms the remaining side edge of the main body chassis 10. Further, the first fixed member 31 has a fringe section 31c, in which tapped holes 31d are formed as illustrated in FIG. 3, and is fixed to the main body chassis 10 by, for example, inserting screw members or the like into the tapped holes 31d.

The first fixed member 31 has a cutout 31a and a recess 31b, as illustrated in FIG. 2 and FIG. 3. Further, the first shaft 35 serving as the shaft for the pivotal motions of the main body chassis 10 and the display chassis 20 is provided in the cutout 31a, and the third shaft 37 is provided in the recess 31b. Further, the first link member 33 is disposed between the cutout 31a and the frame member 12, one end thereof being pivotably journaled by the first shaft 35. The second link member 34 is disposed in the recess 31b, one end thereof being pivotably journaled by the third shaft 37.

The second fixed member 32 is formed in a plate-like shape and disposed adjacently to the frame member 22 of the display chassis 20, as illustrated in FIG. 2 and FIG. 3. In other words, the second fixed member 32 is disposed at a side edge of the display chassis 20 that is connected to the main body chassis 10 and is disposed at a position adjacent to the frame member 22, which forms the remaining side edge of the display chassis 20. Further, the second fixed member 32 has a fringe section 32c, in which tapped holes 32d are formed as illustrated in FIG. 3, and is fixed to the display chassis 20 by, for example, inserting screw members or the like into the tapped holes 32d.

The second fixed member 32 has a cutout 32a and a recess 32b, as illustrated in FIG. 2 and FIG. 3. Further, the second shaft 36 serving as the shaft for the pivotal motions of the main body chassis 10 and the display chassis 20 is provided in the cutout 32a, and the fourth shaft 38 is provided in the recess 32b. Further, the first link member 33 is disposed between the cutout 32a and the frame member 22, the other end thereof being pivotably journaled by the second shaft 36. The second link member 34 is disposed in the recess 32b, the other end thereof being pivotably journaled by the fourth shaft 38.

As illustrated in FIG. 3, the opening of the cutout 31a and the opening of the cutout 32a are formed at opposing positions, and the first link member 33 (including the first shaft 35 and the second shaft 36) is accommodated in the space formed by the cutouts 31a, 32a and the frame member 22. Further, the opening of the recess 31b and the opening of the recess 32b are formed at opposing positions, and the second link member 34 (including the third shaft 37 and the fourth shaft 38) is accommodated in the space formed by the recesses 31b and 32b.

The first link member 33 is provided between the main body chassis 10 and the display chassis 20, as illustrated in FIG. 3. More specifically, the first link member 33 is disposed by being extended between the cutout 31a of the first fixed member 31 fixed to the main body chassis 10 and the cutout 32a of the second fixed member 32 fixed to the display chassis 20. The first link member 33 in the present embodiment is configured to have the same length as that of the second link member 34.

The second link member 34 is provided between the main body chassis 10 and the display chassis 20, as illustrated in FIG. 3. More specifically, the second link member 34 is disposed by being extended between the recess 31b of the first fixed member 31 fixed to the main body chassis 10 and the recess 32b of the second fixed member 32 fixed to the display chassis 20.

As illustrated in FIG. 3, the first shaft 35 is provided on one end of the first link member 33. The first shaft 35 journals one end of the first link member 33 between the cutout 31a of the first fixed member 31 and the frame member 12, thereby pivotably connecting the first link member 33 to the main body chassis 10.

As illustrated in FIG. 3, the second shaft 36 is provided on the other end of the first link member 33. The second shaft 36 journals the other end of the first link member 33 between the cutout 32a of the second fixed member 32 and the frame member 22, thereby pivotably connecting the first link member 33 to the display chassis 20.

As illustrated in FIG. 3, the third shaft 37 is provided on one end of the second link member 34. The third shaft 37 journals one end of the second link member 34 in the recess 31b of the first fixed member 31, thereby pivotably connecting the second link member 34 to the main body chassis 10.

As illustrated in FIG. 3, the fourth shaft 38 is provided on the other end of the second link member 34. The fourth shaft 38 journals the other end of the second link member 34 in the recess 32b of the second fixed member 32, thereby pivotably connecting the second link member 34 to the display chassis 20.

The torque generating mechanism 39A (see FIG. 5) is adapted to generate rotary torques on the first shaft 35 and the second shaft 36. Further, the torque generating mechanism 39B (see FIG. 5; not being illustrated in other drawings) is adapted to generate rotary torques on the third shaft 37 and the fourth shaft 38. The torque generating mechanisms 39A, 39B can be composed of, for example, leaf springs. The leaf springs are wrapped around the first shaft 35 and the second shaft 36, the third shaft 37 and the fourth shaft 38 thereby to enable rotary torques to be generated.

In the present embodiment, the first link member 33 itself is composed of the leaf spring serving as the torque generating mechanism 39A, and the second link member 34 itself is composed of the leaf spring serving as the torque generating mechanism 39B. To compose the first link member 33 itself of a leaf spring (a first leaf spring) serving as the torque generating mechanism 39A, the leaf spring, which has its both ends rounded to match the outside diameters of the first shaft 35 and the second shaft 36, is provided around the first shaft 35 and the second shaft 36 such that the leaf spring extends between the first shaft 35 and the second shaft 36, as illustrated in FIG. 5. Similarly, to compose the second link member 34 itself of a leaf spring (a second leaf spring) serving as the torque generating mechanism 39B, the leaf spring, which has its both ends rounded to match the outside diameters of the third shaft 37 and the fourth shaft 38, is provided around the third shaft 37 and the fourth shaft 38 such that the leaf spring extends between the third shaft 37 and the fourth shaft 38.

Providing the torque generating mechanisms 39A, 39B, as the leaf springs, on the first shaft 35, the second shaft 36, the third shaft 37, and the fourth shaft 38, as illustrated in FIG. 5, makes it possible to generate rotary torques on each of the first shaft 35, the second shaft 36, the third shaft 37, and the fourth shaft 38. In other words, in this case, the first shaft 35, the second shaft 36, the third shaft 37, and the fourth shaft 38 are each provided with the torque generating mechanisms 39A, 39B.

In the hinge mechanisms 30 according to the present embodiment, the torque generating mechanisms 39A, 39B are provided on the shafts, thereby enabling the rotary torque required for opening or closing the main body chassis 10 and the display chassis 20 to be borne by the four shafts in an apportioned manner. This arrangement makes it possible to reduce the wear on or damage to the constituent components (the shafts and the leaf springs) of the torque generating mechanisms 39A, 39B caused by opening and closing, as compared with a conventional hinge mechanism having, for example, only one or two torque generating mechanisms.

Further, as an alternative configuration, the torque generating mechanisms 39A, 39B may be provided only on at least one of the first shaft 35, the second shaft 36, the third shaft 37, and the fourth shaft 38, and not provided on the remaining shafts. In other words, according to the configuration, the rotary torque is generated only on some shafts. In this case, the leaf springs are wrapped on the shafts such that the rotary torque is generated on the first shaft 35, the second shaft 36, the third shaft 37 or the fourth shaft 38 only at the ends of the first link member 33 or the second link member 34 at which the rotary torque is required to be generated, while the leaf springs are wrapped on the shafts with an extremely weak force in comparison at the remaining ends. Alternatively, the ends except for the ends at which the rotary torque is required to be generated may be simply formed in a cylindrical shape or hole that has no spring property.

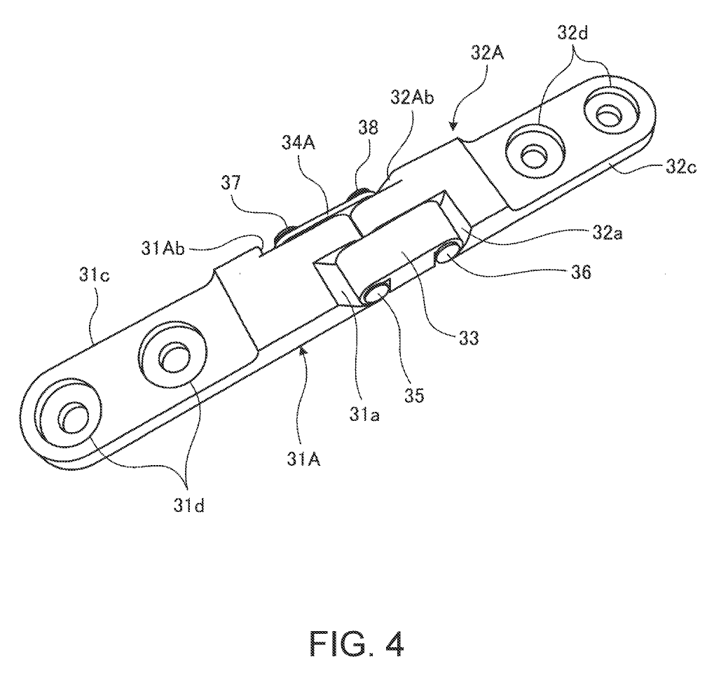

For example, if a rotary torque is to be generated between the first shaft 35 and the second shaft 36 at an end of the first link member 33, and no rotary torque is to be generated between the third shaft 37 and the fourth shaft 38 at an end of the second link member 34 (or only an extremely weak rotary torque in comparison is to be generated), then only the first link member 33 may be composed of a leaf spring, and a second link member 34A may be composed of a plate-like member that is narrower in the axial direction of the third shaft 37 or the fourth shaft 38, as illustrated by the modified example in FIG. 4. In this case, the leaf spring constituting the first link member 33 is wrapped around the first shaft 35 and the second shaft 36 to function as the link mechanism and also as the torque generating mechanism. Further, the plate-like member constituting the second link member 34A functions as a link mechanism that merely connects the third shaft 37 and the fourth shaft 38.

In the example illustrated in FIG. 4, the third shaft 37 or the fourth shaft 38 is configured to be simply inserted in an insertion hole (not illustrated) formed in the narrow plate-like second link member 34A and not to be provided with the torque generating mechanism like the first link member 33. In the drawing, the second link member 34A is composed of the narrow plate-like member, so that a first fixed member 31A and a second fixed member 32A have cutouts 31Ab, 32Ab instead of the recesses 31b, 32b (see FIG. 3) accordingly. Further, the second link member 34A (including the third shaft 37 and the fourth shaft 38) is accommodated in the space formed by the cutouts 31Ab, 32Ab.

In the case of a configuration in which the rotary torque is generated only on some of the shafts is used as illustrated in FIG. 4, even if the torque generating mechanisms 39A, 39B cannot be provided on some of the first shaft 35, the second shaft 36, the third shaft 37, and the fourth shaft 38 because of, for example, chassis made thinner, space saving or some other reason, the rotary torque required to open or close the chassis can be borne by the remaining shafts.

Unlike a conventional two-shaft hinge mechanism, the hinge mechanisms 30 according to the present embodiment each has four shafts, namely, the first shaft 35, the second shaft 36, the third shaft 37, and the fourth shaft 38. The first shaft 35, the second shaft 36, the third shaft 37, and the fourth shaft 38 are disposed such that the axial directions thereof are parallel to each other, as illustrated in FIG. 3. Meanwhile, the first shaft 35, the second shaft 36, the third shaft 37, and the fourth shaft 38 are disposed at different positions when the hinge mechanism 30 is observed sideways rather than being coaxially disposed, as illustrated in FIG. 5.

The hinge mechanisms 30 according to the present embodiment each connects the two chassis by the foregoing non-coaxial four shafts (the first shaft 35 to the fourth shaft 38) and the two link members (the first link member 33 and the second link member 34) journaled by the shafts, thus making it possible to eliminate the hinge block in a conventional hinge mechanism. This permits a considerably reduced number of components, thus enabling the device structure to be significantly smaller and lighter.

### II. Operation of the Hinge Mechanism

Referring now to FIG. 5 to FIG. 13, the pivoting operation of the hinge mechanisms 30 according to the embodiment of the present invention will be described. These drawings illustrate the operation performed by a user holding and opening the display chassis 20 with respect to the main body chassis 10. The drawings illustrate the changes observed at every 45 degrees from the state in which the upper surface 10a of the main body chassis 10 opposes the lower surface 20a of the display chassis 20 (see FIG. 5) to the state in which the lower surface 10b of the main body chassis 10 opposes an upper surface 20b of the display chassis 20 (see FIG. 13).

First, as illustrated in FIG. 5, when the display chassis 20 is closed with respect to the main body chassis 10 and the opening angle of the display chassis 20 with respect to the main body chassis 10 is zero degrees, the first link member 33 and the in second link member 34 cross at a symmetric angle.

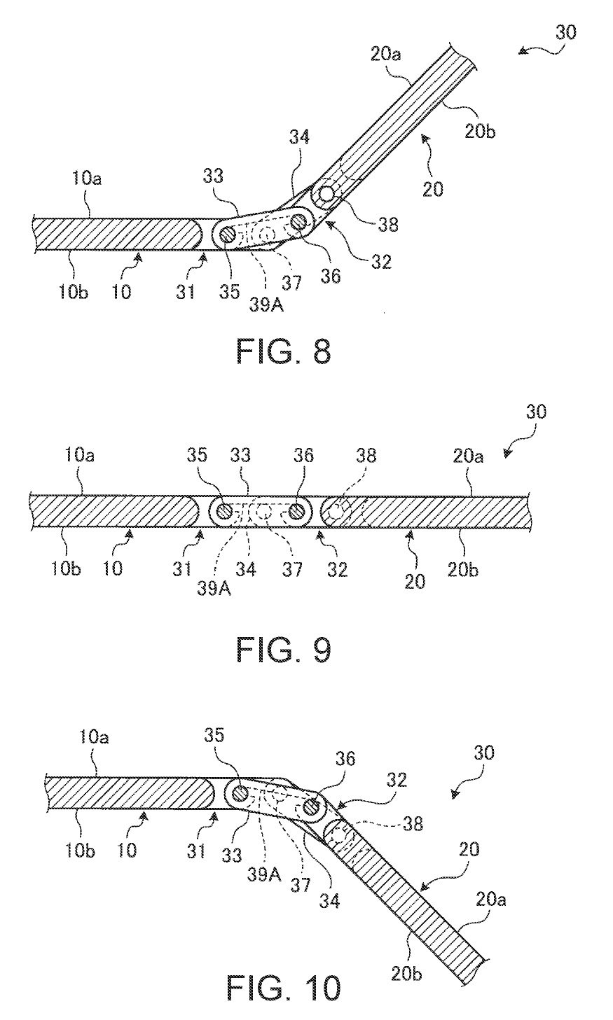

Subsequently, as illustrated in FIG. 6 to FIG. 9, when the display chassis 20 is opened and the opening angle of the display chassis 20 with respect to the main body chassis 10 is changed from zero degrees to 45 degrees (see FIG. 6), 90 degrees (see FIG. 7), 135 degrees (see FIG. 8), and 180 degrees (see FIG. 9), the other end (on the second shaft 36 side) of the first link member 33 rotates clockwise about the first shaft 35 serving as the rotating shaft, and the other end (on the fourth shaft 38 side) of the second link member 34 rotates clockwise about the third shaft 37 serving as the rotating shaft.

In other words, as the angle of the first link member 33 and the second link member 34 with respect to the main body chassis 10 gradually decreases until the opening angle of the display chassis 20 with respect to the main body chassis 10 reaches 180 degrees, as illustrated in FIG. 9, the main body chassis 10, the first link member 33, the second link member 34, and the display chassis 20 are arranged in alignment.

As described above, the hinge mechanisms 30 according to the present embodiment adopt the link mechanism that connects the two chassis by the four non-coaxial shafts (the first shaft 35 to the fourth shaft 38) and the two link members (the first link member 33 and the second link member 34) journaled by the shafts, thus permitting the reduced size. Hence, when the opening angle of the display chassis 20 with respect to the main body chassis 10 is set to 180 degrees (see FIG. 9), the hinge mechanisms 30 will not jut out, thus enabling the main body chassis 10 and the display chassis 20 to be placed in a completely flat state.

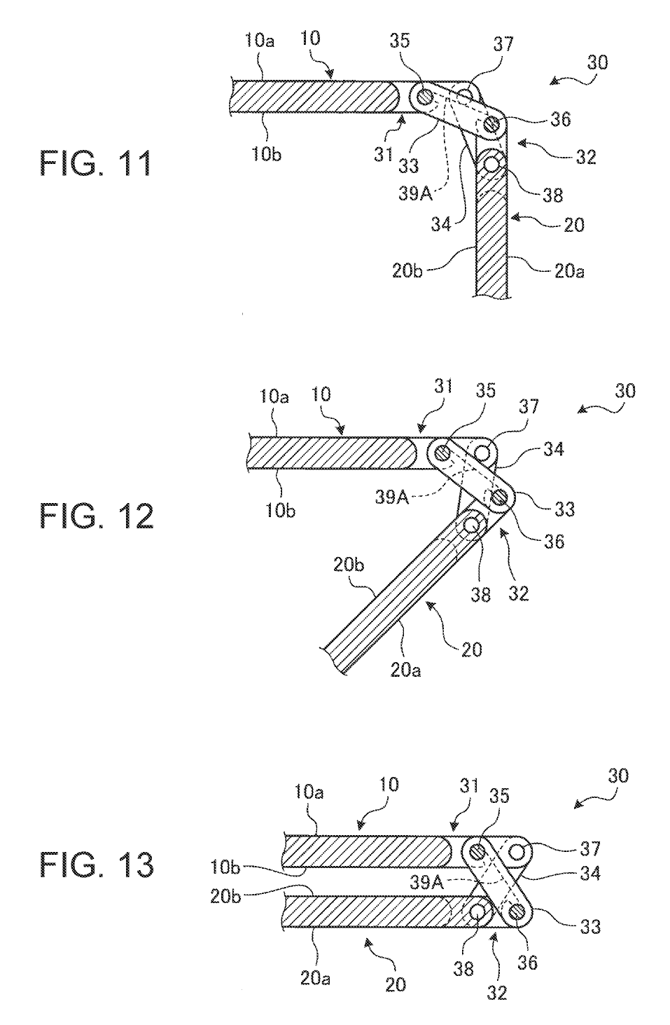

Subsequently, as illustrated in FIG. 10 to FIG. 13, when the display chassis 20 is further opened and the opening angle of the display chassis 20 with respect to the main body chassis 10 is changed from 180 degrees to 225 degrees (see FIG. 10), 270 degrees (see FIG. 11), 315 degrees (see FIG. 12), and 360 degrees (see FIG. 13), the other end (on the second shaft 36 side) of the first link member 33 further rotates clockwise about the first shaft 35 serving as the rotating shaft and the other end (on the fourth shaft 38 side) of the second link member 34 further rotates clockwise about the third shaft 37 serving as the rotating shaft. Then, when the opening angle of the display chassis 20 with respect to main body chassis 10 reaches 360 degrees, as illustrated in FIG. 13, the first link member 33 and the second link member 34 cross at the symmetric angle again.

In the hinge mechanisms 30 according to the present embodiment, as illustrated in FIG. 5 to FIG. 13, the crossing state (crossing angle) of the first link member 33 and the second link member 34 changes according to the opening angle of the display chassis 20 with respect to the main body chassis 10; however, the relationship between the two link members is uniquely determined. More specifically, if the opening angle of the display chassis 20 with respect to the main body chassis 10 is a predetermined angle, then the crossing state of the first link member 33 and the second link member 34 is always a predetermined crossing state.

Further, if the opening angle of the display chassis 20 with respect to the main body chassis 10 is symmetric, then the crossing state of the first link member 33 and the second link member 34 is also symmetric. For example, if the opening angles are zero degrees (see FIG. 5) and 360 degrees (see FIG. 13), then the crossing state of the first link member 33 and the second link member 34 is also symmetric. Further, if the opening angles are 45 degrees (see FIG. 6) and 315 degrees (see FIG. 12), if the opening angles are 90 degrees (see FIG. 7) and 270 degrees (see FIG. 11), and if the opening angles are 135 degrees (see FIG. 8) and 225 degrees (see FIG. 10), then the crossing state of the first link member 33 and the second link member 34 is also symmetric. The foregoing relationship between the opening degree of the display chassis 20 with respect to the main body chassis 10 and the crossing state of the first link member 33 and the second link member 34 remains always the same for the left and the right even in the case where a pair of left and right hinge mechanisms 30 is provided, as illustrated in FIG. 1.

In the hinge mechanisms 30 according to the present embodiment, the first link member 33 and the second link member 34 are always in the crossed state when the display chassis 20 is opened at opening angles except 180 degrees with respect to the main body chassis 10, as illustrated in FIG. 5 to FIG. 8 and FIG. 10 to FIG. 13. This enables the main body chassis 10 and the display chassis 20 to be supported by the two link members in the same manner as, for example, a brace of a building, thus improving the strength of the entire apparatus.

While the above has specifically described the hinge mechanisms and the electronic apparatus provided with the hinge mechanisms according to the present invention with reference to the embodiments for implementing the invention, it is to be understood that the spirit of the invention is not limited thereto and is to be accorded the broadest interpretation based on the description of the appended claims. Further, various modifications, alterations and the like based on the descriptions are obviously included within the spirit of the present invention.

For example, each of the foregoing hinge mechanisms 30 is disposed adjacently to the frame member 12 and the frame member 22, as illustrated in FIG. 2 and FIG. 3. Alternatively, however, the hinge mechanisms 30 may be disposed at the positions of the frame members 12, 22. In other words, the frame members 12, 22 may not be provided in the area where the hinge mechanisms 30 are provided, and the hinge mechanisms 30 may be provided at outermost corners of the electronic apparatus 1.

Further, each of the foregoing hinge mechanisms 30 is disposed adjacently to the frame member 12 and the frame member 22, as illustrated in FIG. 2 and FIG. 3. Alternatively, however, the hinge mechanism 30 may be disposed at positions away from the frame members 12, 22. If the hinge mechanism 30 is provided at positions away from the frame members 12, 22, then the cutout 31a and the cutout 32a are to be formed into recesses which are closed on the frame members 12, 22 side like the recess 31b and the recess 32b rather than being formed to be open on the frame members 12, 22 side.

Further, the foregoing hinge mechanisms 30 are provided in the form of the pair of left and right on the electronic apparatus 1, as illustrated in FIG. 1. Alternatively, however, only one of the hinge mechanisms 30 may be provided at the center in the lateral direction of the electronic apparatus 1, or one or more hinge mechanisms 30 may be additionally provided between the pair of the left and right hinge mechanisms 30.

In the case where two or more of the hinge mechanisms 30 are provided, at least any one of the hinge mechanisms 30 may be provided with the torque generating mechanisms 39A, 39B, while the remaining hinge mechanism or devices 30 may not be provided with the torque generating mechanisms 39A, 39B. Further alternatively, one or a plurality of the hinge mechanisms 30 may be provided with the torque generating mechanisms 39A, 39B, while the remaining one or the plurality of the hinge mechanisms 30 may not be provided with the torque generating mechanisms 39A, 39B. With this arrangement, even if the torque generating mechanisms 39A, 39B cannot be provided on some of the plurality of the hinge mechanisms 30 due to, for example, chassis made thinner or some other reason, the rotary torque required for opening or closing the chassis can be borne by the remaining hinge mechanisms 30.

Further, each of the foregoing hinge mechanisms 30 has the first fixed member 31 and the second fixed member 32 disposed between the first link member 33 and the second link member 34 and the main body chassis 10 and the display chassis 20, as illustrated in FIG. 2 and FIG. 3. Alternatively, however, the first fixed member 31 may be formed integrally with the main body chassis 10 or the second fixed member 32 may be formed integrally with the display chassis 20. In this case, the cutouts 31a, 32a and the recesses 31b, 32b may be directly formed in the rear end portions of the main body chassis 10 and the display chassis 20, and the first link member 33 and the second link member 34 may be disposed therein. With this arrangement, the hinge mechanism can be constructed using only the four shafts (the first shaft 35 to the fourth shaft 38) and the two link members (the first link member 33 and the second link member 34), thus making it possible to further reduce the number of components, as compared with the hinge mechanisms 30 previously described.

Further, in each of the foregoing hinge mechanisms 30, the first link member 33 itself is composed of the leaf spring serving as the torque generating mechanism 39A, and the second link member 34 itself is composed of the leaf spring serving as the torque generating mechanism 39B, as illustrated in FIG. 5. Alternatively, however, the first link member 33 and the torque generating mechanism 39A may be separately constructed, or the second link member 34 and the torque generating mechanism 39B may be separately constructed. In this case, the torque generating mechanism 39A, which is a separate component, may be fixed to the first link member 33, or the torque generating mechanism 39B, which is a separate component, may be fixed to the second link member 34. As an alternative configuration, the torque generating mechanism 39A or the torque generating mechanism 39B may be fixed to the first fixed member 31 or the second fixed member 32 to rotate the first shaft 35, the second shaft 36, the third shaft 37, or the fourth shaft 38.

Further, each of the hinge mechanisms 30 may be configured to generate the rotary torque by, for example, press-fitting the shafts. With this arrangement, even if the torque generating mechanisms 39A, 39B cannot be provided on some of the first shaft 35, the second shaft 36, the third shaft 37, and the fourth shaft 38 due to, for example, chassis made thinner or some other reason, the rotary torque required to open or close the chassis can be borne by the remaining shafts.

Further, in the modified example of the hinge mechanisms 30 described with reference to FIG. 4, the first link member 33 is composed of the leaf spring (the torque generating mechanism), and the second link member 34A is composed of the narrow plate-like member (the link mechanism). Conversely, however, the first link member 33 may be composed of the narrow plate-like member (the link mechanism), and the second link member 34A may be composed of the leaf spring (the torque generating mechanism).

Further, each of the foregoing hinge mechanisms 30 uses the leaf springs as the torque generating mechanisms 39A, 39B, as illustrated in FIG. 5. As an alternative configuration, the rotary torque may be generated by press-fitting the shafts to, for example, the portions that provide bearings.

Further, in each of the hinge mechanisms 30, if, for example, the rotary torque generated by the torque generating mechanisms 39A, 39B is too high or the like and therefore the magnitude of the rotary torque need to be adjusted, then the one or the ones, the rotary torque of which need to be reduced, among the first shaft 35, the second shaft 36, the third shaft 37, and the fourth shaft 38 may be fixed by, for example, swaging, and the rotary torque may be borne by the remaining shafts.

As has been described, the present invention provides a hinge mechanism that openably and closably connects two chassis of an electronic device.

While the invention has been particularly shown and described with reference to a preferred embodiment, it will be understood by those skilled in the art that various changes in form and detail may be made therein without departing from the spirit and scope of the invention.

What is claimed is:

1. A hinge mechanism, comprising:
a first link member and a second link member provided between a first chassis and a second chassis;
a first shaft pivotably connects said first link member to said first chassis;
a second shaft pivotably connects said first link member to said second chassis;
a third shaft pivotably connects said second link member to said first chassis; and
a fourth shaft pivotably connects said second link member to said second chassis, wherein said first, second, third and fourth shafts are not coaxial.

2. The hinge mechanism of claim 1, further comprising a torque generating mechanism configured to generate a rotary torque on at least one of said first, second, third and fourth shafts.

3. The hinge mechanism of claim 2, wherein one of said first and second link members is a leaf spring wrapped around said first and second shafts, and the other of said first and second link members is a plate-like member that connects said first and second shafts, wherein said leaf spring functions as said torque generating mechanism.

4. The hinge mechanism of claim 2, wherein one of said first and second link members is a leaf spring wrapped around said third and fourth shafts, and the other of said first and second link members is a plate-like member that connects said third and fourth shafts, wherein said leaf spring functions as said torque generating mechanism.

5. The hinge mechanism of claim 2, wherein said torque generating mechanism generates a rotary torque on said first, second, third and fourth shafts.

6. The hinge mechanism of claim 5, wherein said torque generating mechanism includes:
a first leaf spring provided around said first and second shafts, and is extendedly provided between said first and second shafts; and
a second leaf spring provided around said third and fourth shafts, and is extendedly provided between said third and fourth shafts.

7. An electronic device, comprising:
a display chassis; and
a body chassis pivotably connected to said display chassis by a hinge mechanism, wherein said hinge mechanism includes
a first link member and a second link member provided between a first chassis and a second chassis;
a first shaft pivotably connects said first link member to said first chassis;
a second shaft pivotably connects said first link member to said second chassis;
a third shaft pivotably connects said second link member to said first chassis; and
a fourth shaft pivotably connects said second link member to said second chassis, wherein said first, second, third and fourth shafts are not coaxial.

8. The electronic device of claim 7, further comprising a torque generating mechanism configured to generate a rotary torque on at least one of said first, second, third and fourth shafts.

9. The electronic device of claim 8, wherein one of said first and second link members is a leaf spring wrapped around said first and second shafts, and the other of said first and second link members is a plate-like member that connects said first and second shafts, wherein said leaf spring functions as said torque generating mechanism.

10. The electronic device of claim 8, wherein one of said first and second link members is a leaf spring wrapped around said third and fourth shafts, and the other of said first and second link members is a plate-like member that connects said third and fourth shafts, wherein said leaf spring functions as said torque generating mechanism.

11. The electronic device of claim 8, wherein said torque generating mechanism generates a rotary torque on said first, second, third and fourth shafts.

12. The electronic device of claim 11, wherein said torque generating mechanism includes:
a first leaf spring provided around said first and second shafts, and is extendedly provided between said first and second shafts; and
a second leaf spring provided around said third and fourth shafts, and is extendedly provided between said third and fourth shafts.
